(19) United States
(12) Patent Application Publication
(10) Pub. No.: US 2024/0375609 A1
(43) Pub. Date: Nov. 14, 2024

(54) Wheel to Pedal Lock

(71) Applicant: Bryan Witchey, Jupiter, FL (US)

(72) Inventor: Bryan Witchey, Jupiter, FL (US)

(21) Appl. No.: 18/197,067

(22) Filed: May 13, 2023

Related U.S. Application Data
(60) Provisional application No. 63/394,489, filed on Aug. 2, 2022.

(51) Int. Cl. B60R 25/022

(52) U.S. Cl. CPC B60R 25/0221

(57) ABSTRACT

A wheel to pedal lock with one end connected a steering wheel and the other end fits around a single brake pedal or two adjacent brake pedals of a vehicle. The wheel to pedal lock comprises: a first elongated member, a rectangular plate, a first hook member, a second hook member, a second elongated member, a third hook member, and a lock mechanism. The first elongated member is perforated to provide a first hole, the second elongated member is perforated to provide a plurality of second holes, wherein when the first hole is aligned with one of the plurality of second holes the lock mechanism is capable of engaging the first hole with the aligned second hole to prevent movement of the first elongated member relative to the second elongated member.

### CROSS-REFERENCE TO RELATED APPLICATIONS

This application claims the benefit of U.S. Application No. 63/394,489, filed Aug. 2, 2022, the content of which is incorporated herein by reference in its entirety.

### STATEMENT REGARDING FEDERALLY SPONSORED RESEARCH OR DEVELOPMENT

Not Applicable.

### FIELD OF THE INVENTION

The invention relates to a wheel to pedal lock.

### BACKGROUND

Various anti-theft devices are used to immobilize vehicles such as ATVs, campers, and pickup trucks. However, there is a need for an improved vehicle anti-theft device.

### SUMMARY

In one non-limiting embodiment of the present invention, a wheel to pedal lock 100 comprises a first elongated member 220, a rectangular plate 280, a first hook member 340, a second hook member 360, a second elongated member 380, a third hook member 400, and a lock mechanism 460; see for example FIGS. 2, 3, 8, 9, 13 and 14.

In one non-limiting embodiment, the first elongated member 220 defines a first opposite end 240 and a second opposite end 260. The rectangular plate 280 is connected to the first opposite end 240 and substantially at right angles thereto, the rectangular plate 280 having a first opposite edge 300 and a second opposite edge 320. The second hook member 360 is connected substantially at right angles to the second opposite edge 320 and extends inwards substantially parallel to the first elongated member 220. The second hook member 360 is connected substantially at right angles to the second opposite edge 320 and extends inwards substantially parallel to the first elongated member 220. The second elongated member 380 has a third hook member 400 extending from a third opposite end 420 of the second elongated member 380, wherein a fourth opposite end 440 of the second elongated member 380 is capable of telescoping into and out of the first elongated member 220 via the second opposite end 260 of the first elongated member 220.

The first elongated member 220 is perforated to provide a first hole 480, the second elongated member 380 is perforated to provide a plurality of second holes 500, wherein when the first hole 480 is aligned with one of the plurality of second holes 500 the lock mechanism 460 is capable of engaging the first hole 480 with an aligned second hole 520 to prevent movement of the first elongated member 220 relative to the second elongated member 380.

### BRIEF DESCRIPTION OF THE DRAWINGS

FIG. 1A shows an environmental view of a wheel to pedal lock according to the invention.

FIG. 1B shows a further environmental view of a wheel to pedal lock according to the invention.

FIG. 2 shows an exploded view of a wheel to pedal lock according to the invention.

FIG. 3 shows an exploded view of a wheel to pedal lock according to the invention.

FIG. 4 shows front perspective view of a wheel to pedal lock according to the invention.

FIG. 5 shows opposite end views of a wheel to pedal lock according to the invention.

FIG. 6A shows a planar side view of a wheel to pedal lock according to the invention.

FIG. 6B shows a planar side view of a wheel to pedal lock according to the invention.

FIG. 6C shows a planar side view of a wheel to pedal lock according to the invention.

FIG. 7 shows a schematic longitudinal section view of a first elongated member and a second elongated member of a wheel to pedal lock in the vicinity of a lock mechanism in the form of a barrel lock according to the invention.

FIG. 8 shows a perspective view of a wheel to pedal lock with a lock mechanism in the form of a barrel lock in a locked configuration according to the invention.

FIG. 9 shows a perspective view of a wheel to pedal lock with a lock mechanism in the form of a barrel lock in an unlocked configuration according to the invention.

FIG. 10 shows a perspective view of a wheel to pedal lock with a lock mechanism in the form of a spring-loaded combination lock in a locked configuration according to the invention.

FIG. 11 shows a perspective view of a wheel to pedal lock with a lock mechanism in the form of a spring-loaded combination lock in an unlocked configuration and also showing a combination lock set key according to the invention.

FIG. 12 shows a perspective view of a wheel to pedal lock with a lock mechanism in the form of a spring-loaded combination lock in an unlocked configuration minus a combination lock set key according to the invention.

FIG. 13 shows an exploded view of a wheel to pedal lock fitted with a lock mechanism in the form of a spring-loaded combination lock according to the invention.

FIG. 14 shows a close up exploded view of the wheel to pedal lock of FIG. 13 according to the invention.

FIG. 15 shows a schematic longitudinal section view of a first elongated member and a second elongated member of a wheel to pedal lock in the vicinity of a lock mechanism in the form of a spring-loaded combination lock in a locked configuration according to the invention.

FIG. 16 shows a schematic longitudinal section view of a first elongated member and a second elongated member of a wheel to pedal lock in the vicinity of a lock mechanism in the form of a spring-loaded combination lock in an unlocked configuration according to the invention.

FIGS. 17A and 17B together make up a single Table (TABLE 1) listing parts thereby providing a useful point of reference.

Similar reference characters denote corresponding features consistently throughout the attached drawings.

### DETAILED DESCRIPTION OF THE INVENTION

It is to be understood that the terms “top”, “bottom”, “left”, “right”, “side”, “front”, “rear”, “upper”, “lower”, “vertical”, “horizontal”, “height”, “width”, “length”, “end” and the like are used herein merely to describe points of reference and do not limit the present invention to any specific orientation or configuration. It should also be understood that the claimed invention and parts may be of any size, shape or configuration suitable for operation of the invention and may be constructed of any suitable materials. Still further, any and all dimensions if shown in attached Figures are example dimensions; dimensions (length, width, height) can vary from those shown.

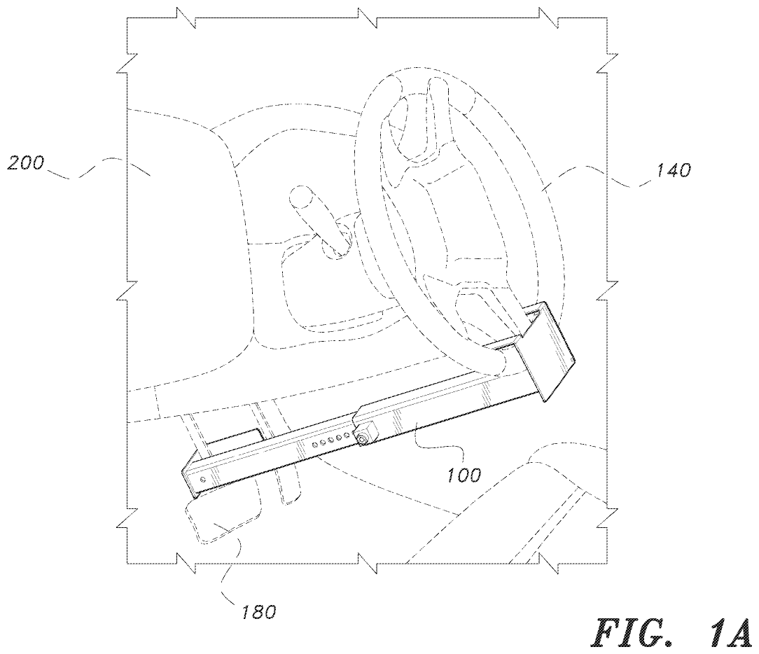

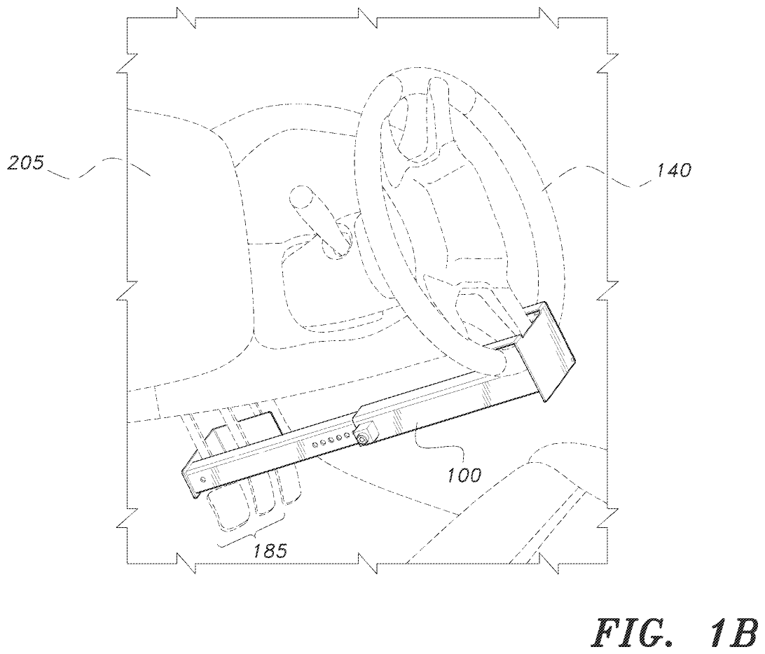

In one embodiment, during normal use, the wheel to pedal lock 100 of the present invention is connected at one end to a steering wheel 140 and the other end fits around a single brake pedal 180 of a vehicle 200 as shown in FIG. 1A.

In one embodiment, during normal use, the wheel to pedal lock 100 of the present invention is connected at one end to a steering wheel 140 and the other end fits around two adjacent brake pedals 185 of a vehicle 205 as shown in FIG. 1B. This is useful because in some agricultural and construction vehicles there are two adjacent brake pedals which allow for individual rear wheel speed (braking) control.

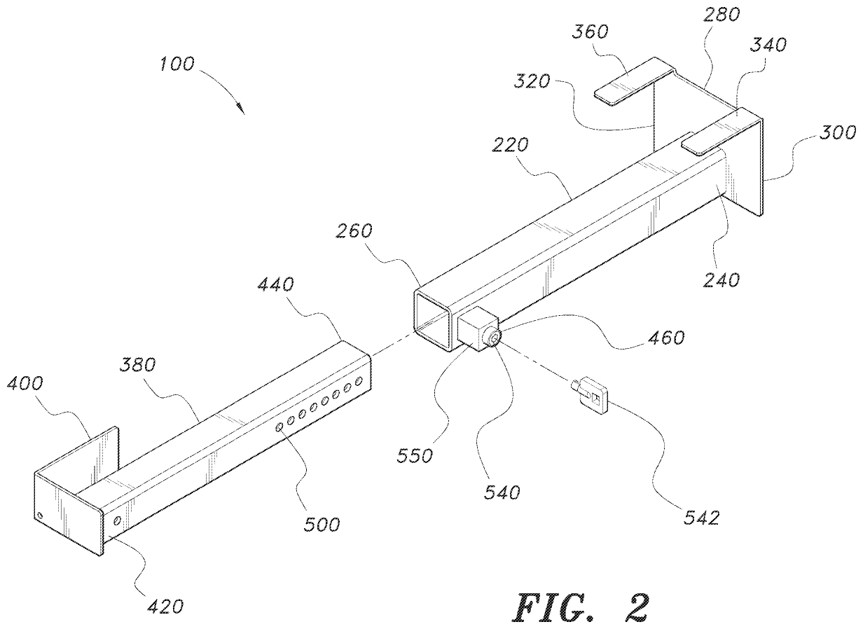

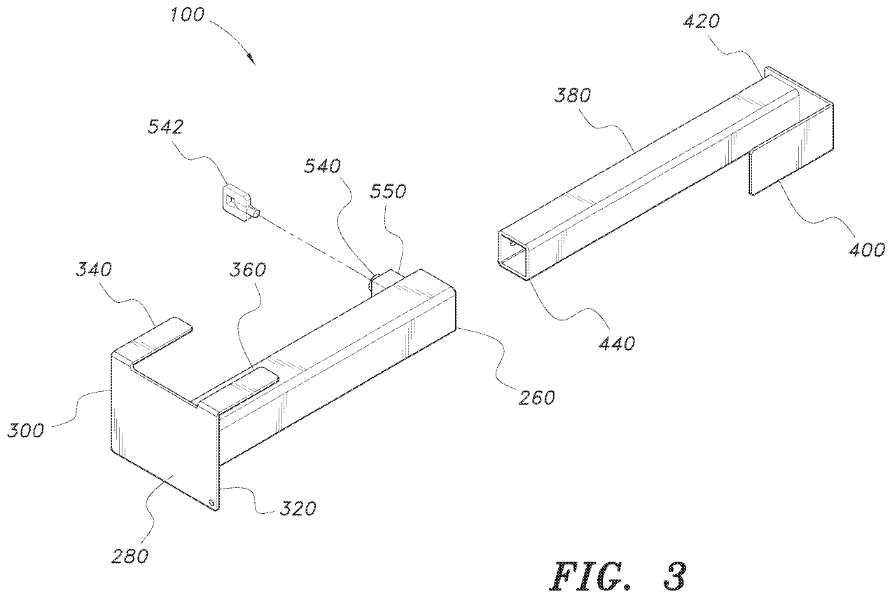

Referring to the Figures in general, the wheel to pedal lock 100 comprises a first elongated member 220, a rectangular plate 280, a first hook member 340, a second hook member 360, a second elongated member 380, a third hook member 400, and a lock mechanism 460; see for example see for example FIGS. 2, 3, 8, 9, 13 and 14.

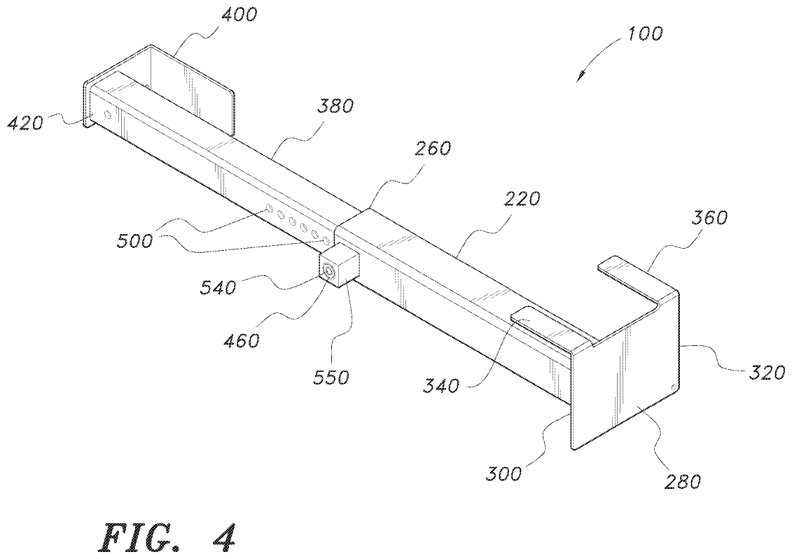

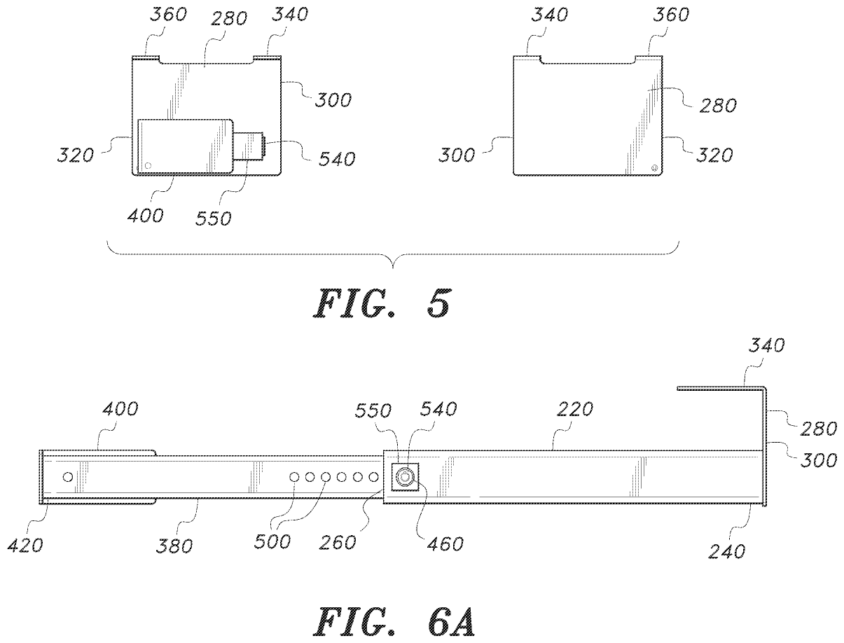

In more detail and referring FIGS. 2 through 5, the first elongated member 220 defines a first opposite end 240 and a second opposite end 260. The rectangular plate 280 is connected to the first end opposite end 240 and substantially at right angles thereto, the rectangular plate 280 having a first opposite edge 300 and a second opposite edge 320. The first hook member 340 is connected substantially at right angles to the first opposite edge 300 and extends inwards substantially parallel to the first elongated member 220. The second hook member 360 is connected at substantially right angles to the second opposite edge 320 and extends inwards substantially parallel to the first elongated member 220.

A third hook member 400 extends inward from a third opposite end 420 of the second elongated member 380, wherein a fourth opposite end 440 of the second elongated member 380 is capable of telescoping into and out of the first elongated member 220 via the second opposite end 260 of the first elongated member 220.

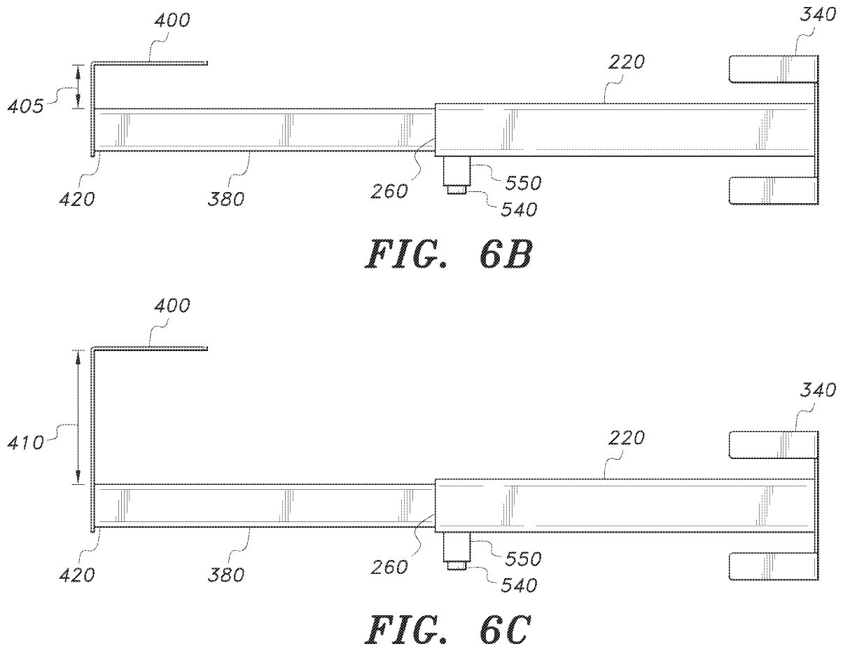

Referring to FIGS. 6A and 6B, the width of the third hook member 400 is of sufficient width 405 or 410 to fit around a single brake pedal 180 (see FIG. 1A) or two adjacent brake pedals 185 (see FIG. 1B), respectively.

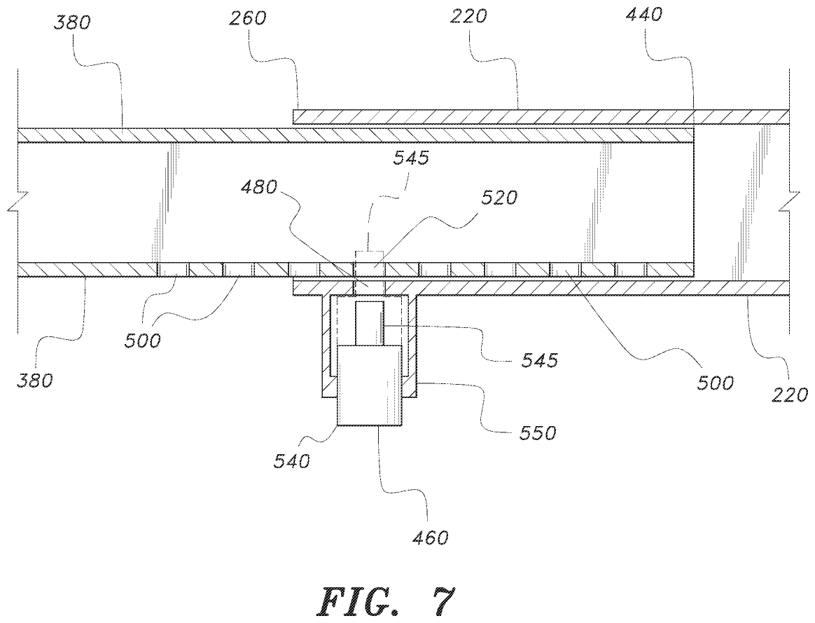

Referring to FIG. 7, the first elongated member 220 is perforated to provide a first hole 480, the second elongated member 380 is perforated to provide a plurality of second holes 500, wherein when the first hole 480 is aligned with one of the plurality of second holes 500 the lock mechanism 460 is capable of engaging the first hole 480 with an aligned second hole 520 to prevent movement of the first elongated member 220 relative to the second elongated member 380.

Still referring to FIG. 7, the lock mechanism 460 is in the form of a barrel lock 540 which has a lock pin 545; the barrel lock 540 is at least partly located in a barrel lock housing 550. The barrel lock 540 is shown in its unlocked position in solid lines. The barrel lock 540 may be moved to a locked position, shown in phantom, in which the lock pin 545 is inserted through the first hole 480 in the first elongated member 220 and the aligned second hole 520.

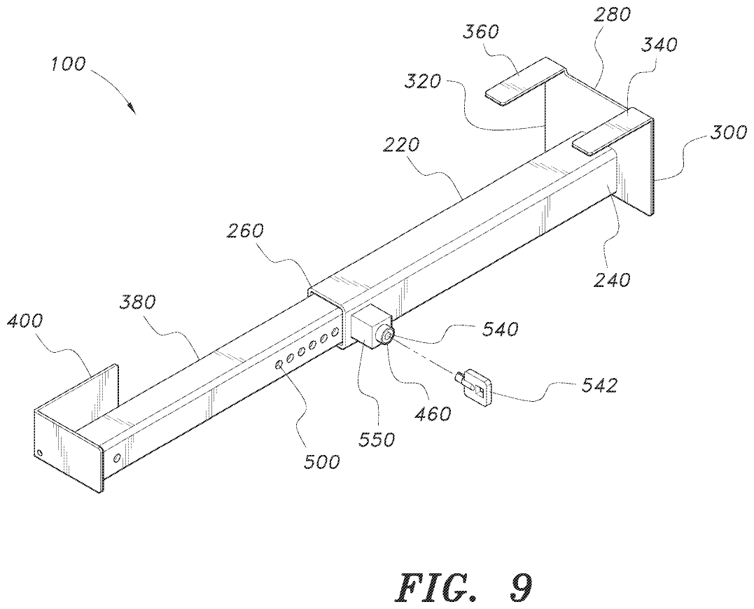

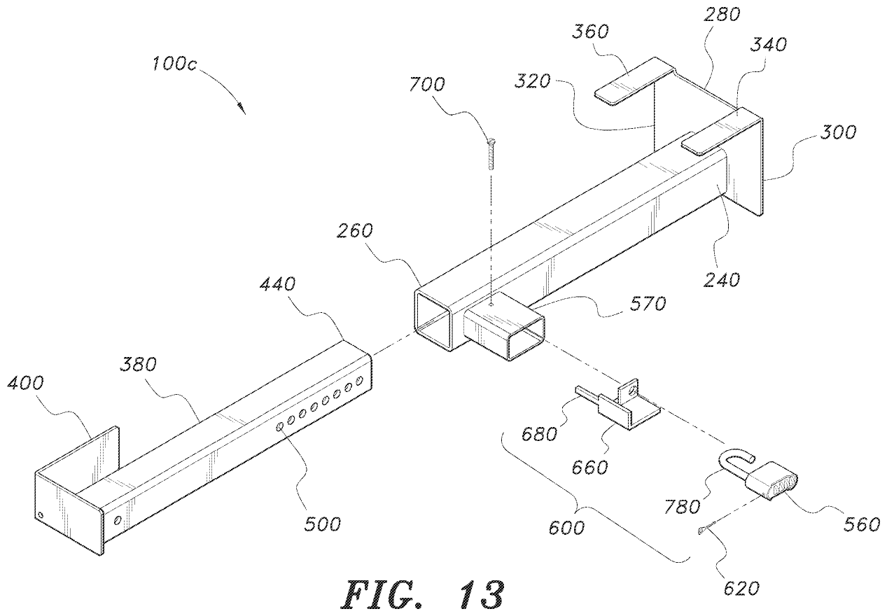

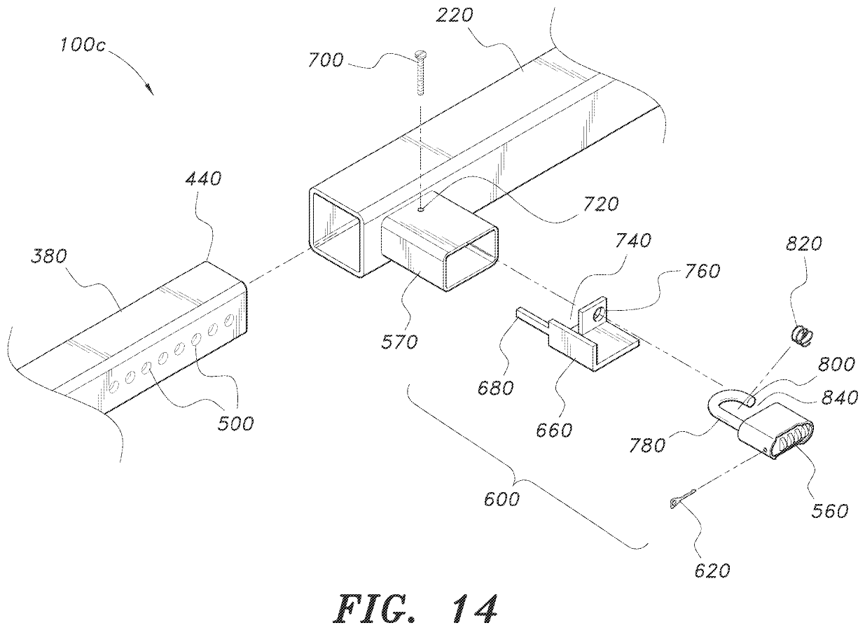

It should be understood that the form of the lock mechanism 460 can vary and is expressly not limited to a barrel lock 540. If present, the barrel lock 540 can be operated using any suitable key such as, but not limited, a barrel lock key 542 shown, for example, in FIG. 9. Neither is the lock mechanism 460 limited to a spring-loaded combination lock 600 as shown, for example, in FIGS. 13 and 14.

It should be understood that the term “substantially” as used herein means the rectangular plate 280 and hooks 340 and 360 should be set at an angle sufficient to enable their function in securing a steering wheel 140 of a vehicle 200 as shown in FIG. 1.

Likewise, it should be understood that the term “substantially” as used herein also means the first hook member 340 and second hook member 360 extend inwards substantially parallel to the first elongated member 220 sufficient to enable their function in securing a steering wheel 140 of a vehicle 200 as shown in FIG. 1.

It should be understood that the term “sufficient” as used herein means the width of the third hook member 400 is of sufficient width 405 or 410 to fit around a single brake pedal 180 or two adjacent brake pedals 185, respectively (see FIGS. 6A and 6B, respectively).

In one embodiment, the lock mechanism 460 is a barrel lock 540. In another embodiment, the lock mechanism 460 comprises a combination lock 560. In one embodiment, the lock mechanism 460 is located proximate to the second opposite end 260 of the first elongated member 220. In one embodiment, the lock mechanism 460 is located at the second opposite end 260 of the first elongated member 220. However, it should be understood that the exact location of the lock mechanism 460 can vary.

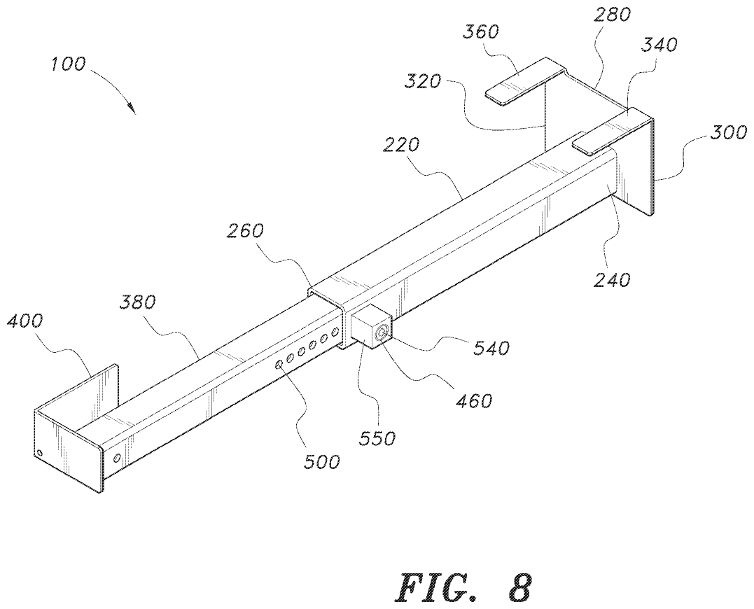

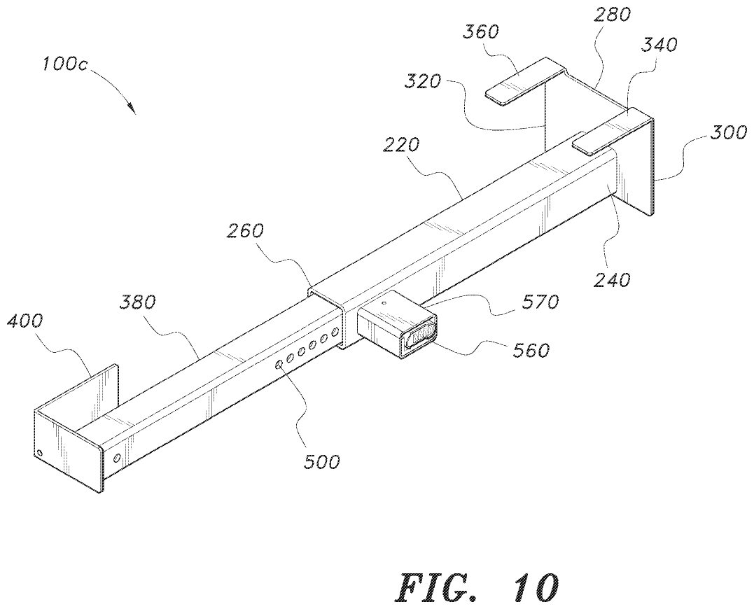

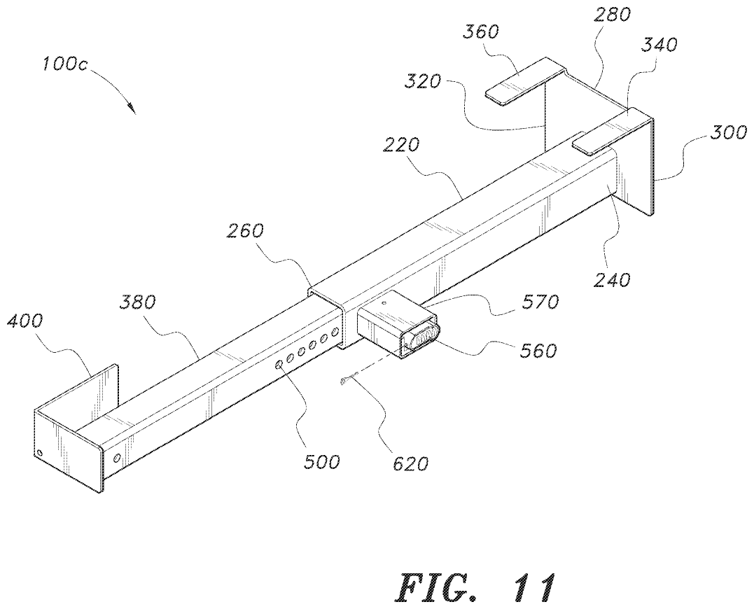

Referring now to FIGS. 8 and 9 of which FIG. 8 shows a perspective view of a wheel to pedal lock 100 with a lock mechanism 460 (in the form of a barrel lock 540) in a locked configuration. In contrast, the barrel lock 540 is shown in an unlocked configuration in FIG. 9. The barrel lock 540 is operated using barrel lock key 542. FIG. 10 shows a combination lock 560 which forms part of a spring-loaded combination lock 600 (shown, for example, in FIGS. 13 and 14 where the lock mechanism is in the form of a spring-loaded combination lock 600). The combination lock 560 is shown in its locked position. The combination lock 560 is mostly surrounded by a combination lock housing 570. The label “100c” refers to a wheel to pedal lock fitted with a combination lock 560 which forms part of a spring-loaded combination lock 600. (Purely for convenience the label “100c” is used throughout FIGS. 10 through 16.)

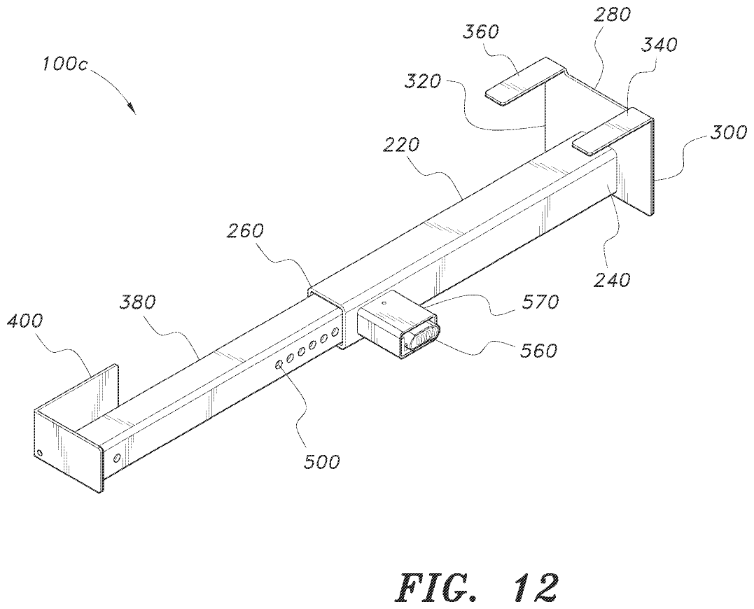

In FIG. 11, the combination lock 560 is shown in its unlocked position. The combination lock 560 is partly protruding from the combination lock housing 570. A combination lock set key 620 is used to set the combination of the combination lock 560 while the combination lock 560 is in its unlocked position. It should be understood that the combination lock set key 620 is optional such that the combination lock 560 may be opened by finger input by a human (not shown); a combination lock lacking a combination lock set key 620 is shown, for example, in FIG. 12.

FIG. 13 shows an exploded view of one optional form of the lock mechanism 460 in the form of a spring-loaded combination lock 600. The spring-loaded combination lock 600, which includes the combination lock 560, further comprises a lock bracket 660 used to hold the combination lock 560. A bracket tongue 680 extends from the lock bracket 660. A securing member 700 is used to secure the combination lock 560 in the combination lock housing 570. During installation of the combination lock 560, the securing member 700 is inserted into the spring-loaded combination lock 600 via a securing hole 720 (shown in FIG. 14).

FIG. 14 provides a close up view of the spring-loaded combination lock 600. A lock bracket gap 740 is located in the lock bracket 660. The lock bracket 660 defines a lock bracket hole 760. The combination lock 560 defines a combination lock hook 780. The combination lock hook 780 fits through the lock bracket gap 740 allowing hook end 800 of the combination lock hook 780 to fit through the lock bracket hole 760. As can be seen in FIG. 14, the spring-loaded combination lock 600 further comprises a spring 820. The combination lock hook 780 is shown in an unlocked configuration with a hook gap 840 visible. The spring 800 is confined within the confines of the combination lock hook 780.

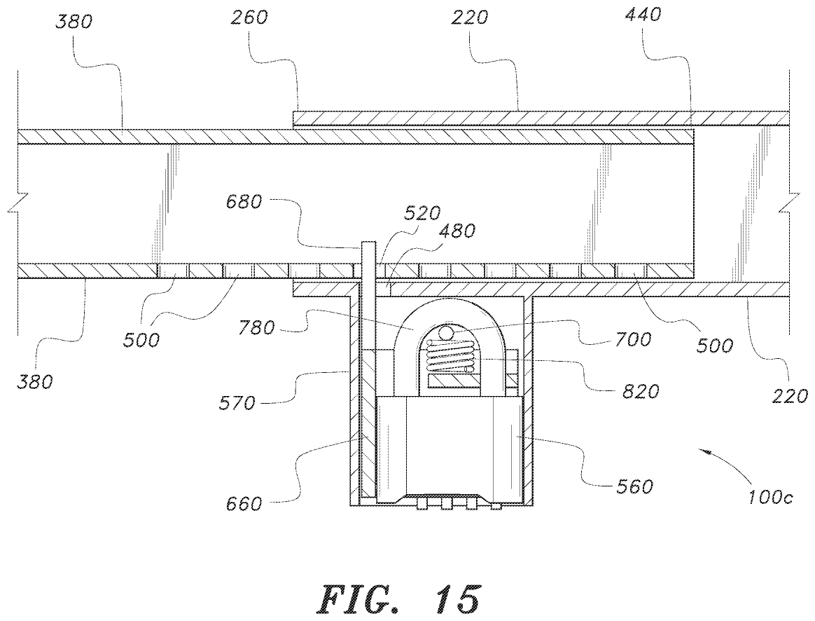

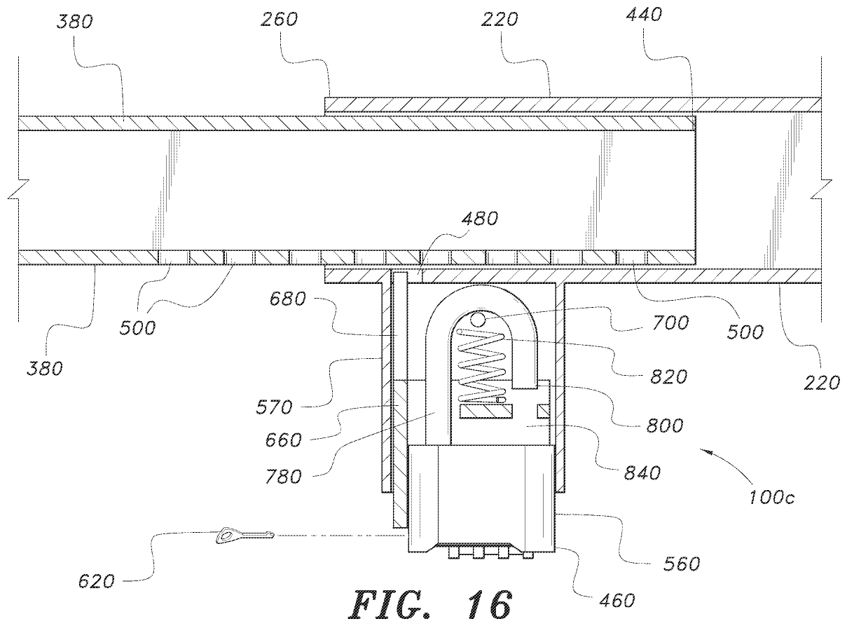

FIG. 15 shows a schematic longitudinal section view of the spring-loaded combination lock with the combination lock 560 in its locked configuration. The combination lock hook 780 is shown in a locked position with the spring 800 compressed. The bracket tongue 680 is shown inserted through the first hole 480 in the first elongated member 220 and one of a plurality of second holes 500 in the second elongated member. More specifically, the bracket tongue 680 is shown inserted through the first hole 480 and an aligned second hole 520 thereby preventing the movement of the first elongated member 220 relative to the second elongated member 380. Thus, when the first hole 480 is aligned with one of the plurality of second holes 500 the lock mechanism 460 is capable of engaging the first hole 480 with the aligned second hole 520 to prevent movement of the first elongated member 220 relative to the second elongated member 380.

FIG. 16 shows a schematic longitudinal section view of the spring-loaded combination lock with the combination lock 560 in its unlocked configuration. In this configuration the spring 800 is decompressed having pushed the combination lock 560 partly out of its housing 570. The combination lock hook 780 is shown in an open state (revealing hook gap 840) following a correct input into the combination lock 560 by the human user (not shown). The bracket tongue 680 has withdrawn from the aligned second hole 520 thereby permitting movement of the first elongated member 220 relative to the second elongated member 380.

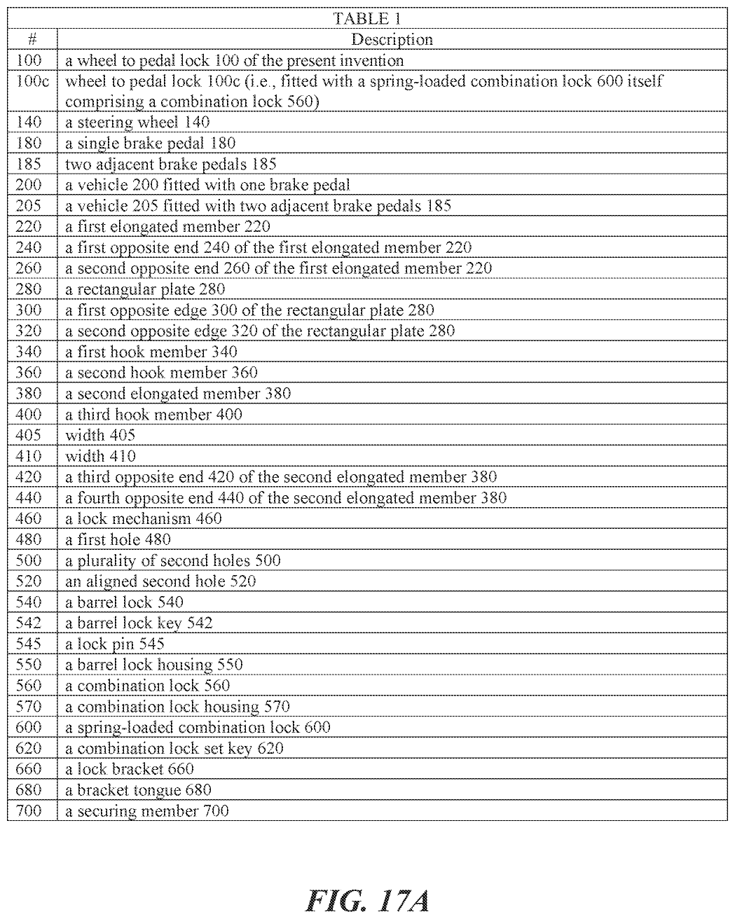

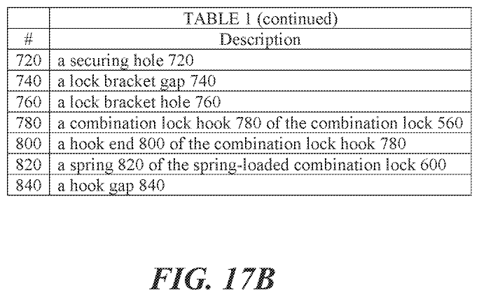

FIGS. 17A and 17B together make up a single Table (TABLE 1) listing parts thereby providing a useful point of reference; in the unlikely event that the number descriptions found in FIGS. 17A and 17B appear to differ from the descriptions found in the specification herein then the descriptions found in the specification take priority.

In one embodiment the wheel to pedal lock 100, comprises:
a first elongated member 220 that defines a first opposite end 240 and a second opposite end 260;
a rectangular plate 280 connected to the first opposite end 240 at right angles thereto, the rectangular plate 280 having a first opposite edge 300 and a second opposite edge 320;
a first hook member 340 connected at right angles to the first opposite edge 300 and extends inwards parallel to the first elongated member 220;
a second hook member 360 connected at right angles to the second opposite edge 320 and extends inwards parallel to the first elongated member 220;
a third hook member 400 extends inward from a third opposite end 420 of a second elongated member 380, wherein a fourth opposite end 440 of the second elongated member 380 is capable of telescoping into and out of the first elongated member 220 via the second opposite end 260 of the first elongated member 220;
a lock mechanism 460; and
wherein the first elongated member 220 is perforated to provide a first hole 480, the second elongated member 380 is perforated to provide a plurality of second holes 500, wherein when the first hole 480 is aligned with one of the plurality of second holes 500 the lock mechanism 460 is capable of engaging the first hole 480 with an aligned second hole 520 to prevent movement of the first elongated member 220 relative to the second elongated member 380.

In one embodiment the wheel to pedal lock 100, comprises:
a first elongated member 220 that defines a first opposite end 240 and a second opposite end 260;
a rectangular plate 280 connected to the first opposite end 240 at right angles thereto, the rectangular plate 280 having a first opposite edge 300 and a second opposite edge 320;
a first hook member 340 connected at right angles to the first opposite edge 300 and extends inwards parallel to the first elongated member 220;
a second hook member 360 connected at right angles to the second opposite edge 320 and extends inwards parallel to the first elongated member 220;
a third hook member 400 extends inward from a third opposite end 420 of a second elongated member 380, wherein a fourth opposite end 440 of the second elongated member 380 is capable of telescoping into and out of the first elongated member 220 via the second opposite end 260 of the first elongated member 220;
a lock mechanism 460, wherein the lock mechanism 460 comprises a combination lock 560; and
wherein the first elongated member 220 is perforated to provide a first hole 480, the second elongated member 380 is perforated to provide a plurality of second holes 500, wherein when the first hole 480 is aligned with one of the plurality of second holes 500 the lock mechanism 460 is capable of engaging the first hole 480 with an aligned second hole 520 to prevent movement of the first elongated member 220 relative to the second elongated member 380.

In one embodiment the wheel to pedal lock 100, comprises:
a first elongated member 220 that defines a first opposite end 240 and a second opposite end 260;
a rectangular plate 280 connected to the first opposite end 240 at right angles thereto, the rectangular plate 280 having a first opposite edge 300 and a second opposite edge 320;
a first hook member 340 connected at right angles to the first opposite edge 300 and extends inwards parallel to the first elongated member 220;
a second hook member 360 connected at right angles to the second opposite edge 320 and extends inwards parallel to the first elongated member 220;
a third hook member 400 extends inward from a third opposite end 420 of a second elongated member 380, wherein a fourth opposite end 440 of the second elongated member 380 is capable of telescoping into and out of the first elongated member 220 via the second opposite end 260 of the first elongated member 220;
a lock mechanism 460, wherein the lock mechanism 460 is a spring-loaded combination lock 600; and
wherein the first elongated member 220 is perforated to provide a first hole 480, the second elongated member 380 is perforated to provide a plurality of second holes 500, wherein when the first hole 480 is aligned with one of the plurality of second holes 500 the lock mechanism 460 is capable of engaging the first hole 480 with an aligned second hole 520 to prevent movement of the first elongated member 220 relative to the second elongated member 380.

In one non-limiting embodiment, the wheel to pedal lock 100 is made of steel.

In one non-limiting embodiment, the wheel to pedal lock 100c is made of steel.

In one non-limiting embodiment, the wheel to pedal lock 100 is made of composite material.

In one non-limiting embodiment, the wheel to pedal lock 100c is made of composite material.

In one non-limiting embodiment, the wheel to pedal lock 100 is made of a combination of composite material and steel. For example, the amount of composite can vary between 5% and 95% the remaining being steel. In one embodiment, the amount of steel varies between 5% and 95% the remaining being composite material.

In one non-limiting embodiment, the wheel to pedal lock 100c is made of a combination of composite material and steel. For example, the amount of composite can vary between 5% and 95% the remaining being steel. In one embodiment, the amount of steel varies between 5% and 95% the remaining being composite material.

The composite material can take any suitable form such as, but not limited to, fiber-reinforced plastic.

Patents which explain how to make and mould fiber-reinforced plastics include, alone or in combination, as follows: U.S. Pat. No. 4,255,087 (to Wackerle, et al, “Member formed of fiber-reinforced plastic material, such as a rotor blade”), U.S. Pat. No. 4,188,032 (to Yanagiok, “Nickel-plated golf club shaft made of fiber-reinforced plastics”), U.S. Pat. No. 4,339,490 (to Yoshioka, et al, “Fiber reinforced plastic sheet molding compound”), U.S. Pat. No. 4,696,459 (to Woltron, et al, “Plastic leaf spring with at least one spring-eye body or spring-eye section”), U.S. Pat. No. 4,671,842 (to Prochaska, et al, “System for the manufacture of tubular structural parts of a fiber-reinforced plastic”), U.S. Pat. No. 4,234,190 (to Airhart, “Carbon fiber-reinforced plastic arrow”), U.S. Pat. No. 6,797,331 (to Singler, et al, “Process for producing a chemical-resistant protective layer for a rotary body having a base body made from fiber-reinforced plastic”), U.S. Pat. No. 5,665,470 (to Key, et al, “Glass fibers and fiber-reinforced plastics”), U.S. Pat. No. 5,601,493 (to Nakazono, et al, “Drive shaft made of fiber reinforced plastics, and method for connecting pipe made of fire-reinforced plastics”), U.S. Pat. No. 5,534,318 (to Andre De La Porte, et al, “Hollow fiber-reinforced plastic body”), U.S. Pat. No. 10,611,057 (to Taketa, et al), U.S. Pat. No. 9,751,239 (to Murai, et al, “Method and device for molding fiber-reinforced plastic member”), U.S. Pat. No. 9,574,081 (to Ishimoto, et al, “Epoxy-resin composition, and film, prepreg and fiber-reinforced plastic using the same”), U.S. Pat. No. 9,168,801 (to Dicke, et al, “Transverse link made of fibre-reinforced plastics material for a wheel suspension of a vehicle”), U.S. Pat. No. 7,083,199 (to Graber, et al, “Chassis part consisting of fiber-reinforced plastics, equipped with an integrated sensor”), U.S. Pat. No. 8,376,426 (to Choi, et al, “Plastic composite bumper beam for vehicle”), U.S. Pat. No. 10,773,472 (to Takano, et al, “Method for manufacturing fiber-reinforced plastic molded body”), and U.S. Pat. No. 10,227,464 (to Saji, “Fiber-reinforced plastic shaped product”).

Composite materials that can also be used in the present invention include those described in: U.S. Pat. No. 11,220,465 (to Kubo, et al, “Method for producing SiC/SiC composite material”), U.S. Pat. No. 11,208,535 (to Ochi, et al, “Production method for prepreg, and production method for fiber-reinforced composite material”), U.S. Pat. No. 11,203,178 (to Kuroda, “Reinforced substrate for composite material, composite material, and method for manufacturing reinforced substrate for composite material”), U.S. Pat. No. 11,187,09 (to Ochi, et al, “Coating-liquid-impregnated fiber-reinforced fabric, sheet-shaped integrated object, prepreg, prepreg tape, and method for manufacturing fiber-reinforced composite material”), U.S. Pat. No. 11,208,911 (to Sadler, et al, “Turbine shroud ring segments with ceramic matrix composite components”), U.S. Pat. No. 11,198,651 (to Sadler, et al, “Turbine shroud ring segments with ceramic matrix composite components”) “); and U.S. Pat. No. 11,198,924 (to Chandrasekaran, et al, “Composite materials”).

It is to be understood that the present invention is not limited to the embodiments described above, but encompasses any and all embodiments within the scope of the following claims.

1. A wheel to pedal lock (100), comprising:
a first elongated member (220) defines a first opposite end (240) and a second opposite end (260);
a rectangular plate (280) connected to the first opposite end (240) and substantially at right angles thereto, the rectangular plate (280) having a first opposite edge (300) and a second opposite edge (320);
a first hook member (340) connected substantially at right angles to the first opposite edge (300) and extends inwards substantially parallel to the first elongated member (220);
a second hook member (360) connected substantially at right angles to the second opposite edge (320) and extends inwards substantially parallel to the first elongated member (220);
a second elongated member (380) defines a third opposite end (420) and a fourth opposite end (440), wherein the fourth opposite end (440) of the second elongated member (380) is capable of telescoping into and out of the first elongated member (220) via the second opposite end (260) of the first elongated member (220);
a third hook member (400) extends inward from the third opposite end (420) of the second elongated member (380);
a lock mechanism (460); and
wherein the first elongated member (220) is perforated to provide a first hole (480), the second elongated member (380) is perforated to provide a plurality of second holes (500), wherein when the first hole (480) is aligned with one of the plurality of second holes (500) the lock mechanism (460) is capable of engaging the first hole (480) with an aligned second hole (520) to prevent movement of the first elongated member (220) relative to the second elongated member (380).

2. The wheel to pedal lock (100) according to claim 1, wherein the lock mechanism (460) is a barrel lock (540).

3. The wheel to pedal lock (100) according to claim 1, wherein the lock mechanism (460) is a barrel lock (540) in combination with a barrel lock key (542).

4. The wheel to pedal lock (100) according to claim 1, wherein the lock mechanism (460) is located proximate to the second opposite end (260) of the first elongated member (220).

5. The wheel to pedal lock (100) according to claim 1, wherein the wheel to pedal lock (100) is made of composite material.

6. The wheel to pedal lock (100) according to claim 1, wherein the wheel to pedal lock (100) is made of steel.

7. The wheel to pedal lock (100) according to claim 1, wherein the wheel to pedal lock (100) is made of a combination of composite material and steel.

8. The wheel to pedal lock (100) according to claim 8, wherein the amount of composite varies between 5% and 95% the remaining being steel.

9. The wheel to pedal lock (100) according to claim 8, wherein the amount of steel varies between 5% and 95% the remaining being composite material.

10. The wheel to pedal lock (100) according to claim 1, wherein the lock mechanism (460) is located at the second opposite end (260) of the first elongated member (220).

11. The wheel to pedal lock (100) according to claim 1, wherein the third hook member (400) points inwards in a direction towards the first hook member (340).

12. The wheel to pedal lock (100) according to claim 1, wherein the third hook member (400) is of sufficient width (405) to fit around a single brake pedal (180).

13. The wheel to pedal lock (100) according to claim 1, wherein the third hook member (400) is of sufficient width (410) to fit around two adjacent brake pedals (185).

14. A wheel to pedal lock (100), comprising:
a first elongated member (220) defines a first opposite end (240) and a second opposite end (260);
a rectangular plate (280) connected to the first opposite end (240) at right angles thereto, the rectangular plate (280) having a first opposite edge (300) and a second opposite edge (320);
a first hook member (340) connected at right angles to the first opposite edge (300) and extends inwards parallel to the first elongated member (220);
a second hook member (360) connected at right angles to the second opposite edge (320) and extends inwards parallel to the first elongated member (220);
a second elongated member (380) defines a third opposite end (420) and a fourth opposite end (440), wherein the fourth opposite end (440) of the second elongated member (380) is capable of telescoping into and out of the first elongated member (220) via the second opposite end (260) of the first elongated member (220);
a third hook member (400) extends inward from the third opposite end (420) of the second elongated member (380);
a lock mechanism (460); and
wherein the first elongated member (220) is perforated to provide a first hole (480), the second elongated member (380) is perforated to provide a plurality of second holes (500), wherein when the first hole (480) is aligned with one of the plurality of second holes (500) the lock mechanism (460) is capable of engaging the first hole (480) with an aligned second hole (520) to prevent movement of the first elongated member (220) relative to the second elongated member (380).

15. The wheel to pedal lock (100) according to claim 14, wherein the third hook member (400) is of sufficient width (405) to fit around a single brake pedal (180).

16. The wheel to pedal lock (100) according to claim 14, wherein the third hook member (400) is of sufficient width (410) to fit around two adjacent brake pedals (185).

17. A wheel to pedal lock (100c), comprising:
a first elongated member (220) defines a first opposite end (240) and a second opposite end (260);
a rectangular plate (280) connected to the first opposite end (240) and substantially at right angles thereto, the rectangular plate (280) having a first opposite edge (300) and a second opposite edge (320);
a first hook member (340) connected substantially at right angles to the first opposite edge (300) and extends inwards substantially parallel to the first elongated member (220);
a second hook member (360) connected substantially at right angles to the second opposite edge (320) and extends inwards substantially parallel to the first elongated member (220);
a second elongated member (380) defines a third opposite end (420) and a fourth opposite end (440), wherein the fourth opposite end (440) of the second elongated member (380) is capable of telescoping into and out of the first elongated member (220) via the second opposite end (260) of the first elongated member (220);
a third hook member (400) extends inward from the third opposite end (420) of the second elongated member (380);
a lock mechanism (460), wherein the lock mechanism (460) comprises a combination lock (560); and
wherein the first elongated member (220) is perforated to provide a first hole (480), the second elongated member (380) is perforated to provide a plurality of second holes (500), wherein when the first hole (480) is aligned with one of the plurality of second holes (500) the lock mechanism (460) is capable of engaging the first hole (480) with an aligned second hole (520) to prevent movement of the first elongated member (220) relative to the second elongated member (380).

18. The wheel to pedal lock (100c) according to claim 17, wherein the lock mechanism (460) is located proximate to the second opposite end (260) of the first elongated member (220).
